(19) United States
(12) Patent Application Publication
(10) Pub. No.: US 2008/0133651 A1
(43) Pub. Date: Jun. 5, 2008

(54) Method for Increasing Performance of Web Browser Based Applications

(75) Inventors: Tekin Bagci, Istanbul (TR); Cetin Bagci, Istanbul (TR); Metin Bagci, Istanbul (TR)

Correspondence Address: AKERMAN SENTERFITT, P.O. BOX 3188, WEST PALM BEACH, FL, 33402-3188, US

(73) Assignee: Bilmed Bilgisayar Ve Yazilim Limited Sirketi, Istanbul (TR)

(21) Appl. No.: 11/671,327

(22) Filed: Feb. 5, 2007

(30) Foreign Application Priority Data
Dec. 1, 2006 (TR) 2006/06833

(51) Int. Cl. G06F 15/16

(52) U.S. Cl. 709/203

(57) ABSTRACT

The invention relates to a method for increasing performance for all applications provided by use of Internet or Intranet based web browsers, by use of AJAX approach supported by all popular web browsers developed between client (2) and server (1) and used in the market, and it consists of the steps wherein an asynchronous request (4) made by the said client (2) is not responded by the said server (1) promptly and is taken into awaiting (5); the asynchronous request (5) awaited by the said server is responded when needed, asynchronous response (6) is formed, the said client (2) performs the required operation receiving the asynchronous request response (6) and makes another asynchronous request (4) to be awaited by the said server (1).

### RELATED ART

The invention relates to method developed for increasing performance of all applications performed by use of Internet or Intranet based web browsers (Internet Explorer, Opera, Mozilla, Firefox, Netscape and Safari)

### BACKGROUND OF THE ART

In the present related art, when a page or an address is requested from the web browser, if the related browser handles the request and sends its response. In general context, when the client requests some services, the browser produces the services in the server and responses. The data transmitted by the server is displayed by the web browser.

In the server-client architecture used in existing applications is in the position of server; audience in general meaning, waits for requests, performs the service and recalls the results. On the other hand, the client sends the request to the server and waits for the result to be sent.

It is not likely for the said server to reach the client sending request or to send any data. The relationship between the server and the client is one direction. The server cannot send data to the client unless the client sends a request, and is only in position of listening. The said architecture has disadvantages of not transferring in particular the data renewed on server. When it is considered that the data on the said server changes and such changes should be submitted to the client using or required to be informed of such data, this disadvantage is seen very clearly.

The applications in use today, bring the solution to this issue by means of requiring the clients to make request from the server at certain time intervals. In this method if expected change has not occurred on the server, the requests cause busy traffic in the network, and bring extra burden to server and client.

Due to the disadvantages mentioned above, the method of client's making request from the server at certain time intervals have not been accepted commonly.

In order to ensure sustainable communication between the client and the server today, the technologies of ActiveX by Microsoft and Java Applet by Sun firm are used. Java Applet technology of the said technologies consists of a dynamic java program compiled at a browser having Java Virtual Machine. The said ActiveX technology which is another technology in use is a technology, developed by Microsoft and consisting of various programming tools and providing an interactive environment between the web used and the connected site and providing operation of objects independent of programming languages. Since the ActiveX objects are the programs operating in the user's computer, any and all sources including user's disks are accessible and therefore, it has some disadvantages in terms of security.

The said two technologies can only be operated upon installation of a new attachment to the browsers. In addition, the code operating in the said technologies is mostly no on the server side but client side. This case causes various security problems. Several web browsers restrict such applications because of security problem of the operating system.

Today, in addition to the above mentioned technologies, AJAX, an approach developed by use of HTML/XHTML, XML, CSS, DOM, JS and XMLHTTPREQUEST objects formed by use of initial letters of the words Asynchronous JavaScript and XML” together with one of the server side languages (PHP, ASP, JSP etc.) is used.

When the said technologies and all former technical documents are examined, no effective method enabling access of the server to the client at any time it requires so has not been seen.

In conclusion, an effective method enabling the server to maintain the communication between the server and the client and access of the server to the clients connected to it at any time it deems necessary by use of the facilities provided by web browsers without need to install any application onto client site is needed, and insufficiency of the existing solutions required a development in the related art.

### BRIEF DESCRIPTION OF THE INVENTION

The present invention relates to a method increasing performance of the browser based applications, which eliminates all the disadvantages and provides some additional advantages.

From the background of the related art, the purpose of the invention is to provide installing any application on the client side unnecessary.

The purpose of the invention is to provide preventing any security deficits that might occur due to failure to install any application on the client side.

The purpose of the invention is to provide the server to access to its connected clients when required.

Another purpose of the invention is to prevent the network traffic and intensity caused by continuous communication provided by means of the client's requests made to the server at certain time intervals.

In order to achieve all of the advantages mentioned above and to be understood better from the detailed description below, the present invention provides several facilities with its said features.

The structural and characteristics features and all advantages of the invention will be more clearly understood with the block chart and the detailed description given below by means of referring to the block chart, and the evaluation should be made taking into consideration the block chart and detailed description.

### DESCRIPTION OF FIGURES

For the best understanding of the embodiment of the invention and additional components as well as advantages, it should be considered together with the block chart described below.

FIG. 1 is the block chart describing the communication between server and client with operating principles of the method being subject of this invention.

### REFERENCE NUMBERS

1. Server

2. Client

3. Normal request

4. Asynchronous request

5. Awaited asynchronous request

6. Response to asynchronous request

### DETAILED DESCRIPTION OF THE INVENTION

In this detailed description, the method to increase the performance of browser based applications has been described in order to make it understood better an has no restrictive effects.

The invention is a method for increasing performance developed for all applications executed by use of Internet or Intranet based web browsers.

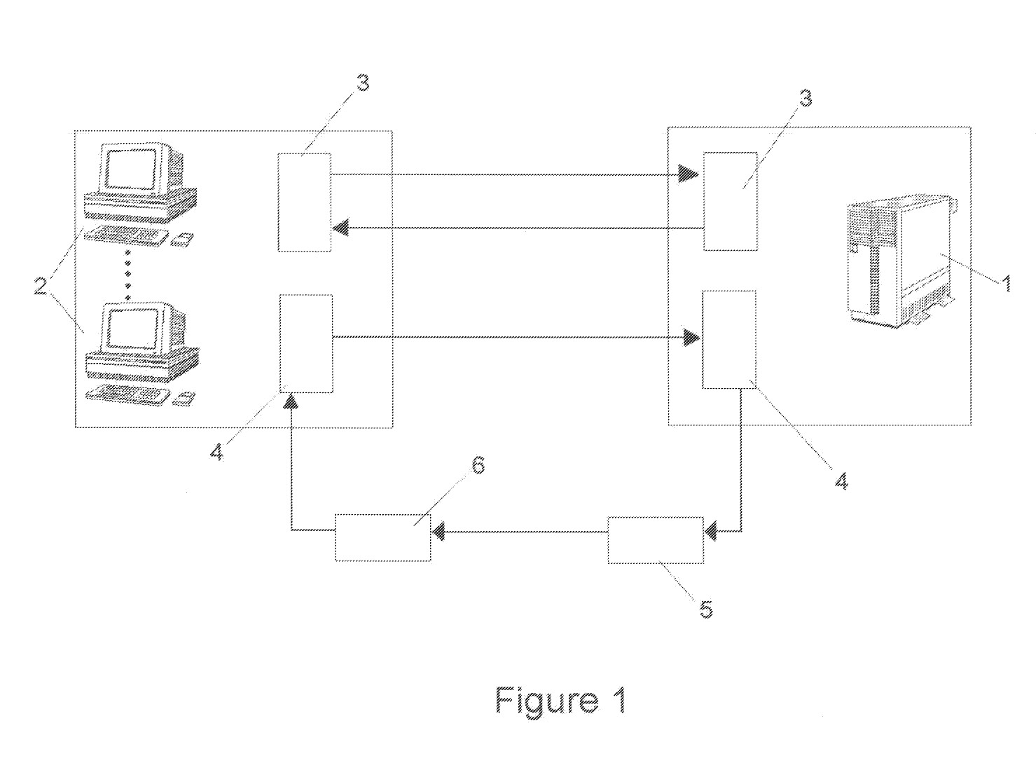

The operation of the method mentioned in block chart indicated in FIG. 1 has been described with flow diagram. The said method is used with an approach called AJAX supported by all popular web browsers available in the market currently.

In the communication between the server (1) and client (2) used in the applications, when the client (2) sends a normal request (3), the said server (1) responds to the received request (3) and performs the service and sends back the results.

In AJAX application, when one of the operations available on the page is triggered, XMLHTTPREQUEST object is formed with the javascript functions kept ready on the page. The object requests performance of the operation from the file existing on the said server (1) side and written in a server based language for the requested operation, and takes the print out of the file and transmits it to other components for processing on the said client (2) side and presentation in the requested form. The said AJAX is not a technology developed by any firm but an approach enabling operation of asynchronous (non-simultaneous/real timed) server code of the said browsers.

By use of this method developed with the facilities provided by the said browsers, when an asynchronous request (4) is made just when the page is browsed onto the browser, the said server (1) responds to the request (4) when required and can transmit data or start communication. Since the said request (4) is asynchronous, it does not block the work to the client (2).

The said server (2) does not respond to the asynchronous request (4) promptly and takes the operation into awaiting (5) in other words, it goes into standby mode. The said asynchronous request (4) is not responded by the server (1) promptly then the request (4) is received but responded when needed. The said client (2) receiving the response (6) by the said server (1) performs the required operation and makes an asynchronous request (4) to be awaited on the server (1) side again. Another request (4) by the client (2) receiving asynchronous request response (6) provides continuity of the communication cycle. Upon closing the page on the client (2) side, the request (4) to end the awaited asynchronous request (5) is made to the said server (1) and the communication ends.

The scope of the protection of the invention has been specified under the claims section and can in no event be limited to the description made for representative purpose. It is obvious that a person skilled in the related art can invent the invention by use of similar embodiments and/or can apply this embodiment to similar purpose other fields used in the related art. Therefore, it will be clear that such embodiment will be deprived of innovation and in particular, exceeding the background of the related art.

1. The invention relates to a performance increasing method developed between client and server for all applications provided by use of Internet or Intranet web browsers, and used together with AJAX approach supported by all popular web browsers used in the market and it is characterized in that
an asynchronous request made by the said client is not responded by the said server promptly and is taken into awaiting,
asynchronous request response is formed upon the said asynchronous request taken into awaiting by the said server is responded when required.
the said client receiving the asynchronous request response performs the required action and makes another asynchronous request to be make waited by the said server.

2. A method according to claim 1, wherein upon closing the page on the said client side, a request to end the awaited asynchronous request is given to the said server and the communication is ended.
